(19) United States
(12) Patent Application Publication
(10) Pub. No.: US 2016/0180366 A1
(43) Pub. Date: Jun. 23, 2016

(54) OPTIMIZATION OF PROMOTIONAL REWARDS

(71) Applicant: NCR Corporation, Duluth, GA (US)

(72) Inventor: Dror Ben-Eliezer, Pardes Hanna-Karkur (IL)

(21) Appl. No.: 14/575,632

(22) Filed: Dec. 18, 2014

(51) Int. Cl. G06Q 30/02

(52) U.S. Cl. CPC G06Q 30/0222; G06Q 30/0226

(57) ABSTRACT

Items of a transaction and available promotions applicable to the transaction are obtained. Constraints are placed on the items and the promotions. A maximization goal is defined for a maximum reward for the transaction. The constraints, goal, and attributes of the items for the transaction are expressed in one or more equations and the equations are solved to find the maximum reward available for the transaction. The maximum reward is identified as an optimal redemption value or optimal reward value for the transaction.

### BACKGROUND

Technology has been advancing in recent years at alarming rates. Perhaps, the most amazing aspect of technology advancement is the ease with which new technologies are now integrated into and adopted by industry and society in general.

Retailers and manufactures of products are attempting to learn as much as they can through these new technologies to compete for consumer business. Thus, information is being captured about individual consumers and categories of consumers that behave similarly. The information is used by the retailers to garner customer loyalty as well.

As a result, consumers are typically offered a variety of electronic-based and print-based discounts for the purchase of products or groups of products. Each of these discounts may have restrictions as to how they can be redeemed by the consumer at the time of purchase.

The retailer that sells the products on behalf of a manufacturer generally wants the consumer to obtain the based possible redemption value from all available discounts at the time of a consumer checkout with the retailer. Naturally, the consumer also wants the best possible or maximum discount at the time of checkout as well.

The problem is that as the number of available discounts grow and the number of products in any given transaction grow, the existing technology is not equipped to efficiently and timely resolve what the best discount or set of discounts are for that transaction. This is so because the number of all possible redemption scenarios for a given transaction can take hours or days to resolve for purposes of finding the best redemption scenario for the customer even with the best computing resources.

As a result, the problem of resolving the best combination of discounts for redemption during a given transaction is often left to the consumer to figure out; rather than having a consumer blame a retailer for giving a less than optimal set of discounts to the consumer after that consumer gets home and figures out a better situation for that transaction.

So, at present it is not cost effective or effective from a public relations standpoint for the retailer to resolve a best redemption scenario for a customer during a transaction. This is not satisfactory to the retailer or the consumer.

### SUMMARY

In various embodiments, methods and a system for optimizing promotional rewards are presented.

According to an embodiment, a method for selecting an optimal reward for a consumer transaction is provided. Specifically, attributes for a transaction are obtained and parameters associated with the attributes are constrained. Next, an optimal reward value is found for the transaction based on available promotions and the constrained parameters.

### BRIEF DESCRIPTION OF THE DRAWINGS

FIG. 1 is a diagram of a system for optimizing the selection of an optimal reward for a consumer during a transaction, according to an example embodiment.

FIG. 2 is a diagram of a method for selecting an optimal reward for a consumer transaction, according to an example embodiment.

FIG. 3 is a diagram of another method for selecting an optimal reward for a consumer transaction, according to an example embodiment.

FIG. 4 is a diagram of a promotional reward selection system, according to an example embodiment.

### DETAILED DESCRIPTION

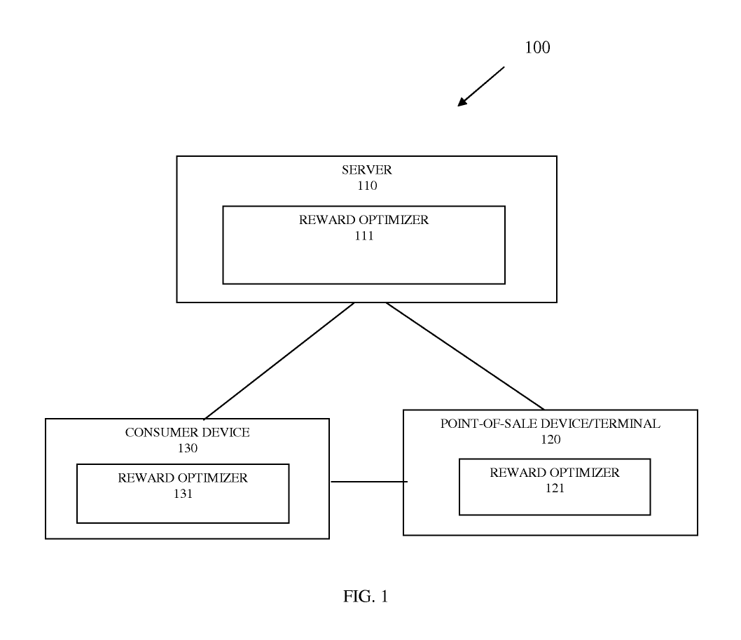

FIG. 1 is a diagram of a system 100 for optimizing the selection of an optimal reward for a consumer during a transaction, according to an example embodiment. The various components are illustrated and the arrangement of the components is presented for purposes of illustration only. It is to be noted that other arrangements with more or less components are possible without departing from the optimal promotional reward selection teachings presented herein and below.

The techniques and methods presented herein and below for transaction-based optimal reward selection can be implemented in whole or in part in one, all, or some combination of the components shown with the system 100. The techniques and methods are programmed as executable instructions in memory and/or non-transitory computer-readable storage media and processed on one or more processors associated with the components.

As used here, the term “product,” “service,” and “good” may be used interchangeably to refer to something being purchased by a consumer from an enterprise. Moreover, the term “promotion” may be used interchangeably with the terms “offer,” “discount,” or “reward” to refer to something that provides a benefit to a consumer in some manner during a transaction. For example, the benefit may be increased reward points for the consumer, a free good with purchase of other goods, a discount purchase price on a good, and the like.

The term “consumer” may be used interchangeably with the terms “customer” and “user” and these terms refer to an entity that is engaged in a transaction with an enterprise for which multiple available promotions exists (some of which may or may not conflict with available promotions) and for which the techniques presented herein provide an efficient selection of an optimal discount or set of discounts from a list of all available discounts to the consumer for a given transaction.

A “promotion redemption” describes a promotion that is triggered, which resources (goods, services, loyalty levels) triggers the promotion and a discount value (benefit) that the resources trigger for the promotion.

For example, consider a promotion P1 that is triggered by the purchase of 2 apples (resources) during a transaction to offer a $1 price discount for the transaction; such redemption may be represented by the tuple [P1, 2 apples, $1].

An “optimal redemption” is a single or set of discounts that can be applied to a given transaction to give a consumer a maximum perceived benefit for that transaction. What is resolved to be “optimal” can be based on price alone, can be based on prior consumer-defined selection rules or preferences based on a profile retained for the consumer, or can be based on a combination of price and consumer-defined selection rules. In essence, an evaluation of all available promotions (with some possible conflicts where one promotion cannot be used when another available promotion is also used) to a transaction (involving a specific customer, specifics goods/services (resources), and/or enterprise performing the transaction) having transaction details is evaluated to select an optimal redemption value (based on price, consumer defined rules available in a profile for that consumer, or both) for the transaction. The optimal redemption value can include a set of available discounts for the transaction from all possible discounts. In an embodiment, the set of available discounts is a single discount.

A “promotion conflict” arises when promotion resources can trigger two or more promotion redemptions. There can be a within-promotion conflict, a between-promotions conflict, and a mixed-promotion conflict.

A “between-promotions conflict” restricts every item (resource for the transaction) to trigger at most one promotion. For example, promotion P1 states buy two apples or oranges and get a $1 discount (reduction in price for the transaction) whereas promotion P2 states buy 3 apples or oranges and get a $1.60 discount. The customer buys 4 apples and 4 oranges in the given transaction.

The “between-promotions conflict” is an allocation of items (resources for the transaction) to multiple available promotions. The optimal resolution assures the best reward for the customer of the transaction. For example, the following redemptions offer a total reward of $4.20: promotion P1 states buy 2 apples get a $1 discount ([P1, 2 apples, $1]); promotion P2 states buy 2 apples plus 4 oranges get a $3.20 discount ([P2, 2 apples+4 oranges, $3.20]). Other resolutions without the between-promotion conflict may yield a $4 discount to a $4.20 discount (reward or reduction in price from the transaction).

A “within-promotion conflict” is a single promotion that is sensitive to the allocation of items (resources) associated with promotion redemptions. For example, promotion P3 states buy 2 drinks and get the least expensive item for free. The customer then buys 2 cokes at a $1 a coke and 2 beers at a $1.50 a beer.

The “within-promotion conflict” is an allocation of items (resources) to promotion redemptions. The optimal resolution assures the best reward (discount or benefit) for the customer during the transaction. For example, the above-example offers redemption for a total reward of $2.50; the example may be expressed as: [P3, 2 cokes, $1] and [P3, 2 beers, $1.50]. Other resolutions may offer only $2.

A “mixed-promotion conflict” is conflicting promotions that restrict every item (resource for the transaction) to trigger at most just one promotion and some of those promotions are sensitive to the allocation of items to promotion redemptions.

Traditionally, the industry has been unable to find the best reward (discount or benefit) for complex conflict scenarios in the fractions of a second necessary to conduct a transaction utilizing a low cost Point-Of-Sale (POS) device/terminal, where the complexity of combinations for the transaction items and promotions can be of magnitude in the Quadrillion (10¹⁵) range of options.

For example, in a between-promotions conflict scenario having 9 items and 5 promotions, every item has at most 5 allocation options so the search space is bounded by 5⁹ (nearly 2 million).

In a mixed-promotion conflict scenario of 9 items and 5 promotions where every promotion has 3 redemption options, every item has at most (3 times 5 (3*5)) allocation options, so the search space is bounded by (3*5)⁹ (nearly 40 billion).

Extreme and yet still realistic options are bounded by 10¹⁵ options. A 1 Gigahertz (Ghz) processor does 10¹⁵ cycles in 11 days. So, a naïve search algorithm may execute for months to resolve an optimal redemption value for such a transaction. One appreciates that this is completely unrealistic when transactions are expected by the consumer and the retailer to complete in fractions of a second.

The techniques herein assume that a promotion can be expressed or is expressed to communicate what it views as a valid redemption (this can be done via rules associated with the promotion). The techniques herein also assume that any conflict has a single metric goal function, such as maximize price discount value, maximize loyalty reward points, or a set of rules (defined by a consumer via rules in a profile) to acquire a maximum metric value for a combination of what the consumer considers to be a maximum benefit based on price discount value and loyalty reward points). However, the single goal is defined and maximized, that goal is referred to as a redemption goal for a given transaction.

The techniques herein use a multi-step process. The first step is an iterative processing step. Each iterated step lists all valid redemption prototypes (available redemption potentials) per one available promotion for the transaction based on all available items (resources) for the transaction. The first step iterates until all the available promotions are processed. The final step is to decide the number of redemption instances per redemption prototype (potential). In an embodiment, the final step includes exponential search-space complexity solved with polynomial approximation using integer linear programming techniques.

For example, consider the first step that is solved with constraint programming techniques, a promotion P1 is stated as buy 2 of resources/items A or B and get a $1 discount off the consumer's transaction. The customer buys 4A and 4B. The valid redemption prototypes that satisfy the promotion's triggering are as follows:

[P1, 2A, $1];

[P1, 2B, $1]; and

[P1, A+B, $1].

The final step is to decide the number of redemption instances, which is solved using integer linear programming. The example of redemptions are (which include 5 redemption prototypes (potentials)) including example output from processing:

[P1, 2A, $1] e.g., output 3;

[P1, 2B, $1] e.g., output 2;

[P1, A+B, $1] e.g., output 5;

[P1, 2A+2B, $1.5] e.g., output 1; and

[P1, 3A+B, $2] e.g., output 2.

Constraint programming is a technique to find solutions in a mathematical model whose requirements are represented by constraints.

The solutions of the algebraic relation is defined by constraints for example A+B=5 and A*B=6. Solution 1 includes decisions where A=2 and B=3 and solution 2 includes A=3 and B=2.

The constraint programming approach is then applied to find the redemption prototypes (potentials). For example, promotion P1 states buy 3 of A, B, or C and get a 10% discount. The consumer then buys 4A, 2B, and 1C. The constraints are defined as: 1) A+B+C=3 (buy 3 to trigger P1); 2) A<=4 (consumer bought 4A); 3) B<=2 (consumer bought 2B); and 3) C<=1 (consumer bought 1C).

With these constraints the feasible solutions are as follows: 1) A=3, B=0, C=0; 2) A=2, B=1, C=0; 3) A=2, B=0, C=1; 4) A=1, B=2, C=0; 5) A=1, B=1, C=1; and 6) A=0, B=2, C=1. So constraints based on what the consumer purchased and based on what the promotion defines are used to arrive at 6 feasible sets of solutions.

Linear Programming (LP) techniques are approaches to achieve the best outcome (such as maximum profit or lowest cost) in a mathematical model whose requirements are represented by linear relationships. If all of the unknown variables are required to be integers, then the problem is referred to as integer linear programming (ILP).

To demonstrate ILP consider the following illustration that asks how may chairs and tables should be produced if a carpenter has 21 m² of wood and is sold at $12; a chair requires 6 m² of wood; and a table requires 7 m² of wood and is sold at $13. The number of chairs (C) is an integer and the number of tables (T) is an integer.

With ILP a formulation that maximizes revenue becomes: 1) a maximizing goal expressed as 12C+13T; and 2) constraints expressed as: a) 6C+7T<=21 (amount of wood the carpenter has); and b) C, T>=0. The ILP solves to find the decisions, which is: C=0, T=3 and revenue=$39.

So, applying ILP to solve a retail transaction scenario with items (resources) A, B, and C for promotions P₁, P₂, and P₃ and redemption values (benefits or discount values) R₁, R₂, and R₃ to decide the number of instances Dᵢ per redemption per promotion may be expressed in a table as follows:

| | Resource | Reward | Decision |
|---|---|---|---|
| Promotion | Usage | Value | Variable |
| P₁ | A, B, C | R₁ | D₁ |
| P₂ | A, 2B | R₂ | D₂ |
| P₃ | A, 3C | R₃ | D₃ |

The goal is to maximize redemption value so: R₁*D₁+R₂*D₂+R₃*D₃. The constraints are expressed as: 1) D₁+D₂+D₃<=Total (A); 2) D₁+2*D₂<=Total (B); 3) D₁+2*D₃<=Total (C); and 4) D₁, D₂, D₃>=0.

Trials have indicated that improvement in resolving an optimal redemption value for a transaction at a POS device/terminal can be increased by as much as a factor of 6300. This makes resolving an optimal redemption for a consumer transaction having multiple items (resources) and multiple promotions (some of which have conflicts with one another) during that transaction practical and feasible. This will improve consumer satisfaction and loyalty to the retailer deploying the techniques and system presented herein.

It is within this context that the system 100 of the FIG. 1 is now discussed.

The system 100 can include: a server 110, a POS device/terminal 120, and/or a consumer device 130. The server 110 may include a reward optimizer 111. The POS device/terminal 120 may include a reward optimizer. The consumer device 130 may include a reward optimizer 131. In an embodiment, each of the server 130, the POS device/terminal 120, and the consumer device 130 include an independent operating instance of the reward optimizer 111, 121, and 131, respectively. In an embodiment, just one of: the server 130, the POS device terminal 120, and the consumer device 130 includes an operating instance of the reward optimizer 111, 121, or 131, respectively. In an embodiment, two of: the server 130, the POS device/terminal 120, and the consumer device 130 include an operating instance of the reward optimizer 111 and 121; 121 and 131; or 111 and 121.

The reward optimizer (111, 121, or 131) is activated during a transaction with a consumer. The items (resources) are identified (such as via a scanner and a Stock Keeping Unit (SKU) number). Attributes for the items are also obtained for the transaction, such as quantity of each unique item purchased, price of each item, store identifier, POS identifier, and the like. Attributes for the transaction as a whole (transaction attributes) are obtained, such as consumer loyalty account identifier to identify the consumer, date and time for the transaction, day of week for the transaction, POS identifier, cashier identifier (if the POS device/terminal 120) is a cashier-assisted terminal, and the like.

Next, the attributes are used to identify promotions available for the transaction or any presented promotions provided by the consumer for the transaction (provided either electronically from the consumer device 130 or manually handed to the cashier in print media form).

Each promotion is associated with a promotion identifier. The item attributes, the transaction attributes and the promotion identifiers are provided to the reward optimizer (111, 121, and/or 131 (through electronic communication between the consumer device 130 and one of: the server 110 and the POS device/terminal 120)).

The promotion identifiers are used by the reward optimizer (111, 121, and/or 131) to locate, perhaps on the server 110, promotion rules. The promotion rules define constraints for a transaction in using the promotion, such as cannot be used with another promotion, can be used with certain other promotions, and the like.

The reward optimizer (111, 121, and/or 131) uses the item attributes, the transaction attributes, and the promotion rules for the promotions associated with the applicable promotion identifiers to initially constrain the variables associated with the transaction to just what the consumer purchased.

Next, a goal for maximizing a reward or redemption value for the transaction is established by the reward optimizer (111, 121, and/or 131). In an embodiment, the default goal is to maximize the amount of discount the consumer is eligible to receive for the transaction. In an embodiment, the goal is acquired from the server 110 based on a set of consumer-defined rules for what is considered to be an optimal redemption value acquired from a profile associated with the consumer (such as maximizing reward points first for the transaction and then discount value).

Then, the reward optimizer (111, 121, and/or 131) identifiers uses the constraints based on the transaction and the goal to find an reward or redemption value for the transaction based on the available promotions and their rules of use and the attributes associated with the items purchased in the transaction and the attributes for the transaction as a whole.

In an embodiment, the optimal reward or redemption value is resolved based on applying a constraint programming algorithm followed by a ILP algorithm, as discussed and illustrated above.

It is again to be noted that the reward optimizer (111, 121, and 131) can be deployed to a server 110, a POS device/terminal 120, and/or a consumer mobile device 130 as a mobile application (app).

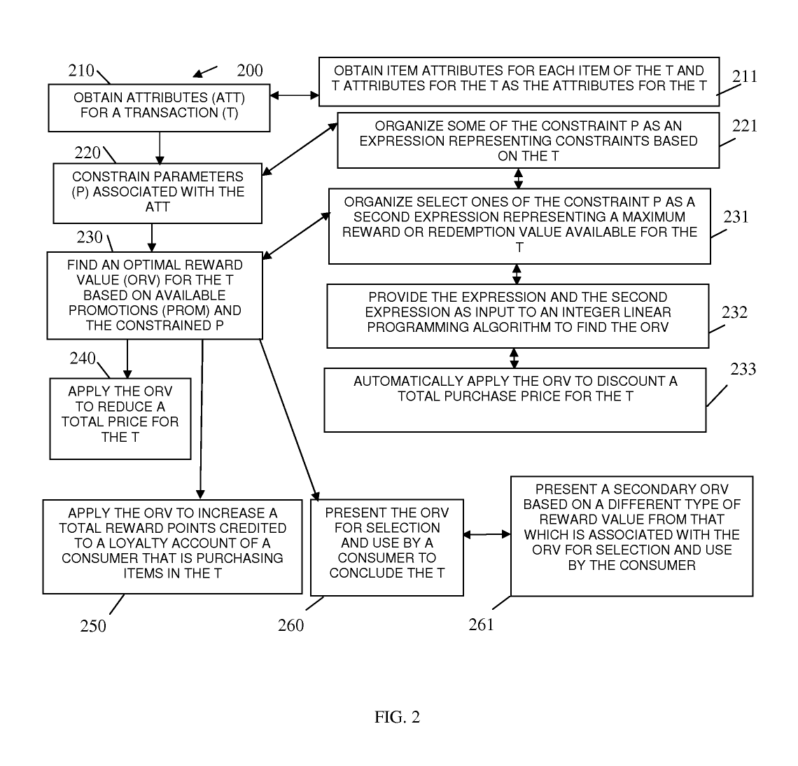

The above-discussed embodiments and other embodiments are now discussed with reference to the FIGS. 2-4.

FIG. 2 is a diagram of a method 200 for selecting an optimal reward for a consumer transaction, according to an example embodiment. The software module(s) that implement the method 200 is referred to as a “reward optimizer.” Moreover, the executable instructions for the reward optimizer are programmed and residing within memory and/or a non-transitory computer-readable (processor-readable) storage medium and executed by one or more processors of a device. The processors are specifically configured and programmed to process the reward optimizer. The reward optimizer may have access to one or more networks. The networks are wired, wireless, or a combination of wired and wireless.

In an embodiment, the device that executes the reward optimizer is a retailer server that is networked to a plurality of POS terminals of the retailer.

In an embodiment, the device that executes the reward optimizer is a device associated with a cloud processing environment.

In an embodiment, the device the device that executes the reward optimizer is a POS terminal. In an embodiment, the POS terminal is a Self-Service Terminal (SST). In an embodiment, the POS terminal is a cashier-assisted terminal.

In an embodiment, the device that executes the reward optimizer is a consumer mobile device. In an embodiment, the mobile device is a mobile phone. In an embodiment, the mobile device is a tablet. In an embodiment, the mobile device is a wearable processing device.

At 210, the reward optimizer obtains attributes for a transaction. The attributes include item identifiers for items being purchased (items referred to as resources above with the description of the FIG. 1), a quantity total for each item, a listed retail price for each item, and other attributes. The attributes also include transaction attributes for the transaction as a whole, such as those listed above with the description of the FIG. 1.

So, according to an embodiment, at 211, the reward optimizer obtains item attributes for items associated with the transaction and transaction attributes associated with the transaction as a whole as the attributes obtained at 210.

At 220, the reward optimizer constrains parameters associated with the attributes. Here, based on the items purchased and the item attributes associated therewith, constraints are expressed in terms of parameters or variables for expression evaluation as discussed above with reference to the FIG. 1 and the discussion of constraint programming.

So, in an embodiment, at 221, the reward optimizer organizes some of the constraint parameters as an expression representing constraints based on the transaction.

At 230, the reward optimizer finds an optimal reward value (discussed above as optimal redemption with the FIG. 1) based on available promotions for the transaction and the constrained parameters.

In an embodiment of 221 and 230, at 231, the reward optimizer organizes select ones of the parameters as a second expression representing a maximum reward value or redemption value available for the transaction.

In an embodiment of 231 and at 232, the reward optimizer provides the expression and the second expression as input to an ILP algorithm to find an optimal reward value.

In an embodiment of 232 and at 233, the reward optimizer automatically applies the optimal reward value to discount a total purchase price for the transaction.

According to an embodiment, at 240, the reward optimizer applies the optimal reward value to reduce a total price for the transaction.

In an embodiment, at 350, the reward optimizer applies the optimal reward value to credit a loyalty account for a consumer conducting the transaction. The optimal reward value credited as loyalty reward points to the account.

According to an embodiment, at 360, the reward optimizer presents the optimal reward value on a screen rendered to a display that the consumer views for the consumer to select for application to the transaction.

In an embodiment of 360 and at 361, the reward optimizer presents a secondary reward value that is a different type of reward value from that which is associated with the optimal reward value for the consumer to decide on whether to use the optimal reward value or the secondary reward value. For example, the reward optimizer may process an optimal reward value by default as an optimal discounted price and independently process a secondary reward value as maximum loyalty points to credit a loyalty account of the consumer for the transaction and the consumer is offered a choice as to which to apply for the given transaction. The two reward values (optimal and secondary) are different types because one is based on currency reduction and one is based on reward point maximization.

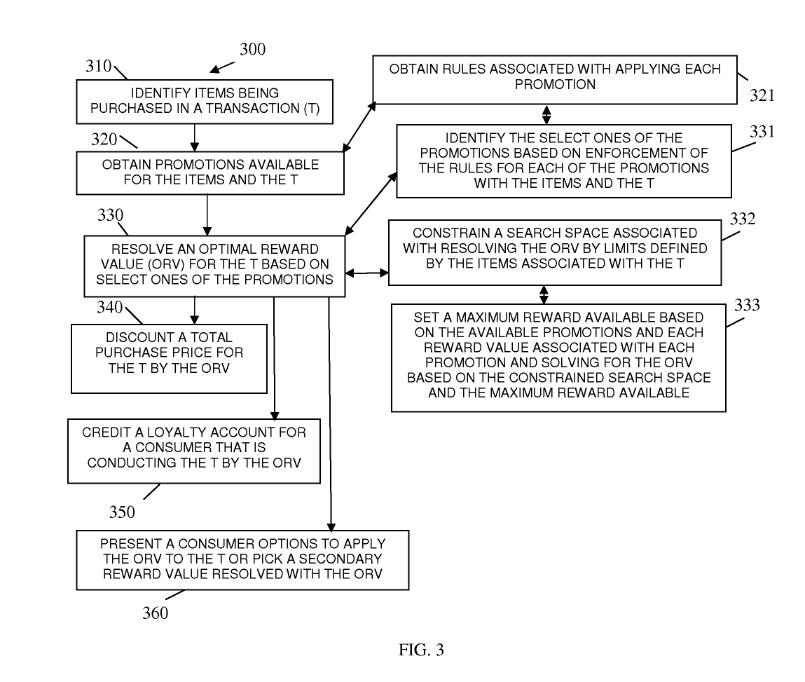

FIG. 3 is a diagram of another method 300 for selecting an optimal reward for a consumer transaction, according to an example embodiment. The software module(s) that implement the method 300 is referred to as a “reward transaction manager.” The executable instructions of the reward transaction manager are implemented as instruction and programmed within memory and/or a non-transitory computer-readable (processor-readable) storage medium that executes on one or more processors of a device; the processors of the device are specifically configured to execute the reward transaction manager. The reward transaction manager may have access to one or more networks; the networks are wired, wireless, or a combination of wired and wireless.

In an embodiment, the reward transaction manager presents another and in some ways enhanced processing perspective to the reward optimizer presented above with the discussion of the method 200 of the FIG. 2.

In an embodiment, the device that executes the reward transaction manager is a retailer server that is networked to a plurality of POS terminals of the retailer.

In an embodiment, the device that executes the reward transaction manager is a device associated with a cloud processing environment.

In an embodiment, the device the device that executes the reward transaction manager is a POS terminal. In an embodiment, the POS terminal is a Self-Service Terminal (SST). In an embodiment, the POS terminal is a cashier-assisted terminal.

In an embodiment, the device that executes the reward transaction manager is a consumer mobile device. In an embodiment, the mobile device is a mobile phone. In an embodiment, the mobile device is a tablet. In an embodiment, the mobile device is a wearable processing device.

At 310, the reward transaction manager identifies items being purchased in a transaction. This can be done in a number of ways, one of which was discussed above with the FIG. 1 (POS terminal communicating item (resource) identifiers to the reward transaction manager during a checkout processing by a consumer conducting the transaction at the POS terminal).

At 320, the reward transaction manager obtains promotions available for the items and the transaction. This can be done by interacting with a retailer server to use attributes associated with the transaction and the items to identify all the promotions that are potentially available for application with the transaction.

According to an embodiment, at 321, the reward transaction manager obtains rules associated with applying each promotion.

At 330, the reward transaction manager resolves an optimal reward value (optimal redemption) for the transaction based on the promotions.

In an embodiment of 321 and 330, at 331, the reward transaction manager identifies select ones of the promotions for application to the transaction based on enforcement of the rules for each of the promotions with the items of the transaction being purchased by a consumer.

In an embodiment, at 332, the reward transaction manager constrains a search space associated with resolving the optimal reward value by limits defined by the items associate with the transaction. This was described and examples provided above with the description of the FIG. 1.

In an embodiment of 332 and at 333, the reward transaction manager sets a maximum reward value based on the available promotions and each reward value associated with each promotion. The reward transaction manager solves the optimal reward value based on the constrained search space and the maximum reward value (as discussed and presented at length with examples above with the description of the FIG. 1).

According to an embodiment, at 340, the reward transaction manager automatically discounts a total purchase price for the transaction by the optimal reward value. Again, this can be done by the reward transaction manager being in electronic communication with a POS terminal that is conducting the transaction.

In an embodiment, at 350, the reward transaction manager credits a loyalty account for a customer that is conducting the transaction with reward points as the optimal reward value.

In an embodiment, at 360, the reward transaction manager presents the consumer (who is conducting the transaction) with options for selection. The options can include applying the optimal reward value to the transaction or applying a secondary reward value (as discussed above at 261 with the discussion of the FIG. 2).

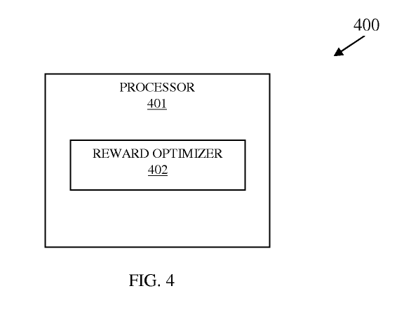

FIG. 4 is a diagram of a promotional reward selection system 400, according to an example embodiment. The components of the promotional reward selection system 400 are programmed and reside within memory and/or a non-transitory computer-readable medium and execute on one or more processors of one or more devices. The promotional reward selection system 400 may be operational over a network and the network can be wired, wireless, or a combination of wired and wireless.

In an embodiment, the promotional reward selection system 400 is the system 100 of the FIG. 1.

In an embodiment, the promotional reward selection system 400 implements, inter alia, the method 200 of the FIG. 2.

In an embodiment, the promotional reward selection system 400 implements, inter alia, the method 300 of the FIG. 3.

Thus, the description above with the FIGS. 1-3 are incorporated by reference herein with the description of the promotional reward selection system 400.

The promotional reward selection system 400 includes a processor 401 having a reward optimizer 402.

The reward optimizer 402 is adapted and configured to: execute on the processor 401, identify available promotions for a transaction, and resolve an optimal reward value (optimal redemption) for the transaction based on select application of particular ones of the available promotions that conform to restrictions associated with those particular available promotions.

In an embodiment, the reward optimizer 402 is the reward optimizer 111, 121, or 131 of the FIG. 1.

In an embodiment, the reward optimizer 402 is the method 200 of the FIG. 2.

In an embodiment, the reward optimizer 402 is the method 300 of the FIG. 3.

According to an embodiment, the reward optimizer 402 is implemented on one of: a server, a cloud device associated with a cloud processing environment, a POS terminal, and a mobile device. In an embodiment, the server is the server 110 of the FIG. 1. In an embodiment the POS terminal is the POS device/terminal 120 of the FIG. 1. In an embodiment, the mobile device is the consumer operated device 130 of the FIG. 1.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
obtaining attributes for a transaction;
constraining parameters associated with the attributes; and
finding an optimal reward value for the transaction based on available promotions and the constrained parameters.

2. The method of claim 1 further comprising, applying the optimal reward value to reduce a total price for the transaction.

3. The method of claim 1 further comprising, applying the optimal reward value to increase a total reward points credited to a loyalty account of a consumer that is purchasing items in the transaction.

4. The method of claim 1 further comprising, presenting the optimal reward value for selection and use by a consumer to conclude the transaction.

5. The method of claim 4, wherein presenting further includes presenting a secondary optimal reward value based on a different type of reward value from that which is associated with the optimal reward value for selection and use by the consumer.

6. The method of claim 1, wherein obtaining further includes obtaining item attributes for each item of the transaction and transaction attributes for the transaction as the attributes for the transaction.

7. The method of claim 1, wherein constraining further includes organizing some of the constraint parameters as an expression representing constraints based on the transaction.

8. The method of claim 7, wherein finding further includes organizing select ones of the constraint parameters as a second expression representing a maximum reward or redemption value available for the transaction.

9. The method of claim 8 further comprising, providing the expression and the second expression as input to an Integer Linear Programming algorithm to find the optimal reward value.

10. The method of claim 9 further comprising, automatically applying the optimal reward value to discount a total purchase price for the transaction.

11. A method, comprising:
identifying items being purchased in a transaction;
obtaining promotions available for the items and the transaction; and
resolving an optimal reward value for the transaction based on select ones of the promotions.

12. The method of claim 11 further comprising, discounting a total purchase price for the transaction by the optimal reward value.

13. The method of claim 11 further comprising, crediting a loyalty account for a consumer that is conducting the transaction by the optimal reward value.

14. The method of claim 11 further comprising, presenting a consumer options to apply the optimal reward value to the transaction or pick a secondary reward value resolved with the optimal reward value.

15. The method of claim 11, wherein obtaining further includes obtaining rules associated with applying each promotion.

16. The method of claim 15, wherein resolving further includes identifying the select ones of the promotions based on enforcement of the rules for each of the promotions with the items and the transaction.

17. The method of claim 11, wherein resolving further includes constraining a search space associated with resolving the optimal reward value by limits defined by the items associated with the transaction.

18. The method of claim 17, wherein constraining further includes setting a maximum reward available based on the available promotions and each reward value associated with each promotion and solving for the optimal reward value based on the constrained search space and the maximum reward available.

19. A system, comprising:
a processor; and
a reward optimizer configured to: i) execute on the processor, ii) identify available promotions for a transaction, and iii) resolve an optimal reward value for the transaction based on select application of particular ones of the available promotions that conform to restrictions associated with those particular available promotions.

20. The system of claim 19, wherein the reward optimizer is implemented on one of: a server, a cloud device associated with a cloud processing environment, a Point-Of-Sale (POS) terminal, and a mobile device.
